(19) United States
(12) Patent Application Publication
(10) Pub. No.: US 2023/0104169 A1
(43) Pub. Date: Apr. 6, 2023

(54) COMMUNICATION MODULE, COMMUNICATION SYSTEM, AND METHOD FOR CONTROLLING COMMUNICATION MODULE

(71) Applicant: KYOCERA CORPORATION, Kyoto-shi, Kyoto (JP)

(72) Inventors: Shinji ISOYAMA, Yokohama-shi, Kanagawa (JP); Hiromichi YOSHIKAWA, Yokohama-shi, Kanagawa (JP); Nobuki HIRAMATSU, Yokohama-shi, Kanagawa (JP); Noriyoshi FUKUTA, Kawasaki-shi, Kanagawa (JP); Tomonao YUZAWA, Kawasaki-shi, Kanagawa (JP)

(21) Appl. No.: 17/911,134

(22) PCT Filed: Mar. 11, 2021
(86) PCT No.: PCT/JP2021/009923

§ 371 Date: Sep. 13, 2022

(30) Foreign Application Priority Data
Mar. 27, 2020 (JP) 2020-058485

(51) Int. Cl. H01Q 21/06

(52) U.S. Cl. CPC H01Q 21/062

(57) ABSTRACT

A communication module includes an antenna, a transmission circuit, a reception circuit, and a controller. The antenna includes a first antenna element at a transmission side and a second antenna element at a reception side and has an isolation characteristic between the first antenna element and the second antenna element. The transmission circuit is connected to the first antenna element. The reception circuit is connected to the second antenna element. The antenna includes a first variable phase unit configured to vary a phase of a transmission wave to be transmitted from the first antenna element and a second variable phase unit configured to vary a phase of a reception wave to be received by the second antenna element. The controller controls at least one of the first variable phase unit or the second variable phase unit to control an isolation of the antenna.

### RELATED APPLICATIONS

The present application is a National Phase of International Application Number PCT/JP2021/009923, filed Mar. 11, 2021, and claims priority based on Japanese Patent Application No. 2020-058485, filed Mar. 27, 2020.

### TECHNICAL FIELD

The present disclosure relates to a communication module, a communication system, and a method for controlling a communication module.

### BACKGROUND ART

When two antennas are brought closer, an isolation therebetween cannot be ensured. To ensure the isolation between the antennas, there is a technique for separating the two antennas and inserting a structure therebetween. Such a technique is described, for example, in Patent Literature 1.

### CITATION LIST

### Patent Literature

Patent Literature 1: JP 2016-105583 A

### SUMMARY OF INVENTION

### Technical Problem

Even the antennas with the isolation therebetween is ensured as described in Patent Literature 1 may sometimes be difficult to ensure the isolation depending on the installation condition of the antennas. The installation situation of the antennas is, for example, a situation in which the environment around the antennas changes due to buildings built around the antennas. When ensuring the isolation is difficult, a reception level of a reception signal when a reception wave from other communication terminals is received by the antenna may decrease, and there is room for improvement.

The present disclosure is to provide a communication module, a communication system, and a method for controlling a communication module that can suitably acquire a reception signal.

### Solution to Problem

A communication module according to one aspect includes an antenna including a first antenna element at a transmission side and a second antenna element at a reception side and having an isolation characteristic between the first antenna element and the second antenna element, a transmission circuit connected to the first antenna element, a reception circuit connected to the second antenna element, and a controller configured to control the antenna, the transmission circuit, and the reception circuit. The antenna includes a first variable phase unit configured to vary a phase of a transmission wave to be transmitted from the first antenna element, and a second variable phase unit configured to vary a phase of a reception wave to be received by the second antenna element. The controller controls at least one of the first variable phase unit or the second variable phase unit to control an isolation of the antenna.

A communication system according to one aspect includes the communication module described above, and a communication terminal configured to communicate with the communication module.

A method for controlling a communication module according to one aspect is a method for controlling the communication module described above includes, by the controller, receiving a reception wave at the second antenna element to acquire a reception signal from the reception circuit and controlling at least one of the first variable phase unit or the second variable phase unit in a manner that a signal level of the reception signal acquired is smaller than a preset setting value.

### Advantageous Effects of Invention

According to the present disclosure, a reception signal can be suitably acquired.

### BRIEF DESCRIPTION OF DRAWINGS

FIG. 1 is a schematic view of a communication system according to an embodiment.

FIG. 2 is a schematic view of an antenna according to the embodiment.

FIG. 3 is a perspective view illustrating an antenna body according to the embodiment.

FIG. 4 is a cross-sectional view of the antenna body taken along a line L1-L1 illustrated in FIG. 3.

FIG. 5 is an exploded perspective view of a part of the antenna body illustrated in FIG. 3.

FIG. 6 is a plan view for describing a configuration of a radiation conductor illustrated in FIG. 3.

FIG. 7 is a flowchart of an example related to a method for controlling a communication module according to the embodiment.

FIG. 8 is a flowchart of an example related to a method for controlling a communication module according to the embodiment.

FIG. 9 is an explanatory diagram related to a cancel signal.

FIG. 10 is a graph showing attenuation characteristics of the antenna with respect to frequencies.

### DESCRIPTION OF EMBODIMENTS

A detailed description of an embodiment according to the present disclosure will be given with reference to the drawings. In the following description, similar constituent elements may be assigned the same reference signs. Furthermore, redundant descriptions may be omitted. In addition, matters that are not closely related to the description of the embodiment according to the present disclosure may be omitted from the description and illustrations. Note that the present disclosure is not limited by the following embodiment. Further, the following embodiment includes elements that can be easily conceived by those skilled in the art, elements that are substantially the same, and elements in a so-called equivalent range.

### EMBODIMENT

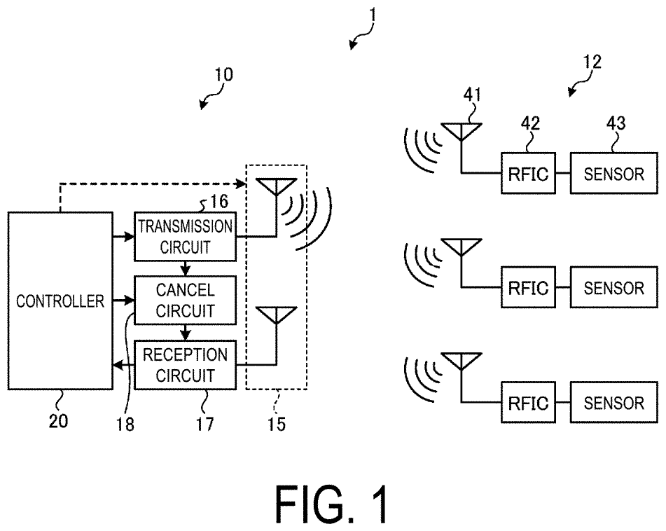

FIG. 1 is a schematic view of a communication system according to the embodiment. The communication system 1 includes a communication module 10 and a plurality of communication terminals 12. The communication system 1 is a system in which the communication module 10 and the plurality of communication terminals 12 are capable of wirelessly and bi-directionally communicating with each other.

The communication module 10 is, for example, a base station. The communication module 10 includes an antenna 15, a transmission circuit 16, a reception circuit 17, a cancel circuit 18, and a controller 20. The communication module 10 transmits a transmission wave from the antenna 15 or receives a reception wave at the antenna 15. Specifically, the communication module 10 converts, at the transmission circuit 16, a transmission signal generated by the controller 20 and transmits the converted transmission signal as a transmission wave from the antenna 15. Furthermore, the communication module 10 acquires a reception signal by receiving a reception wave at the antenna 15 converts the reception signal at the reception circuit 17, and acquire the converted reception signal at the controller 20.

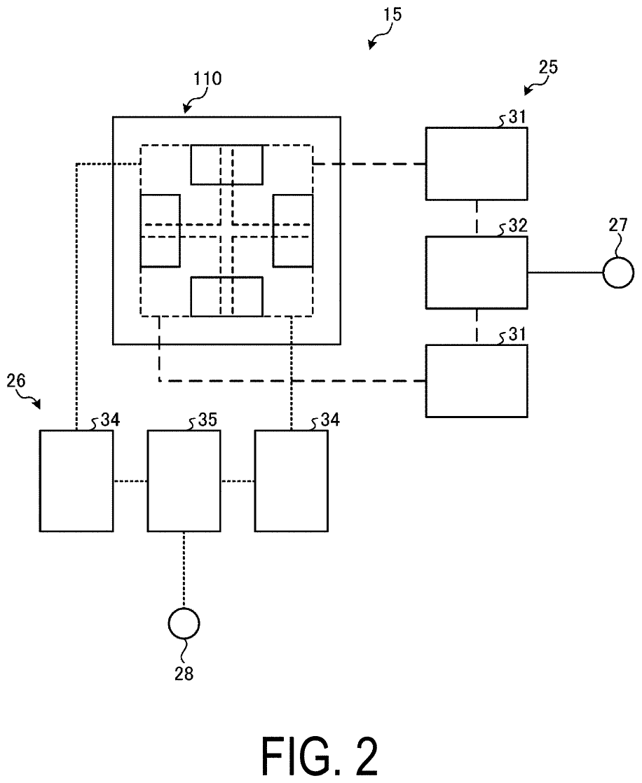

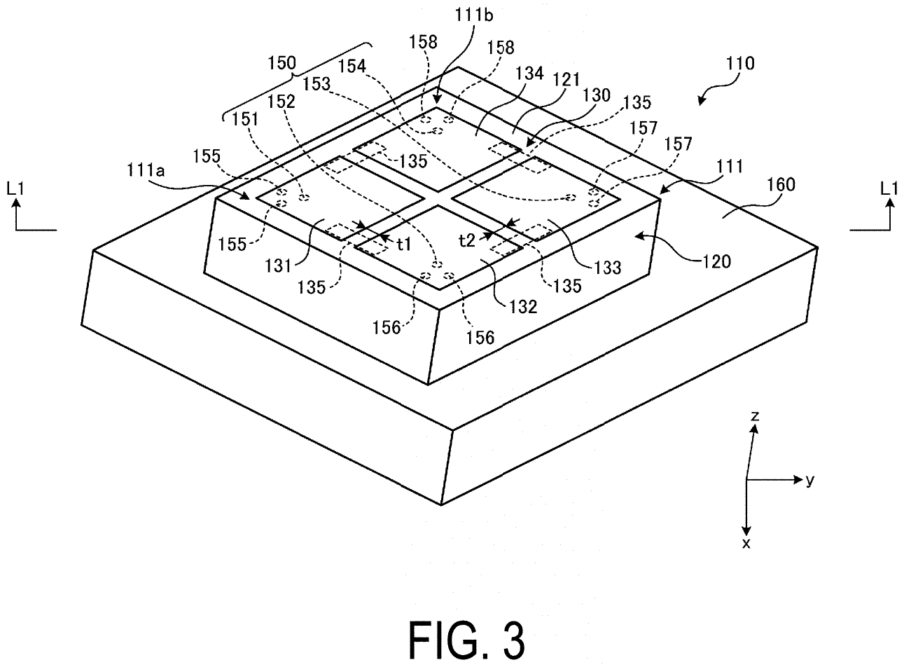

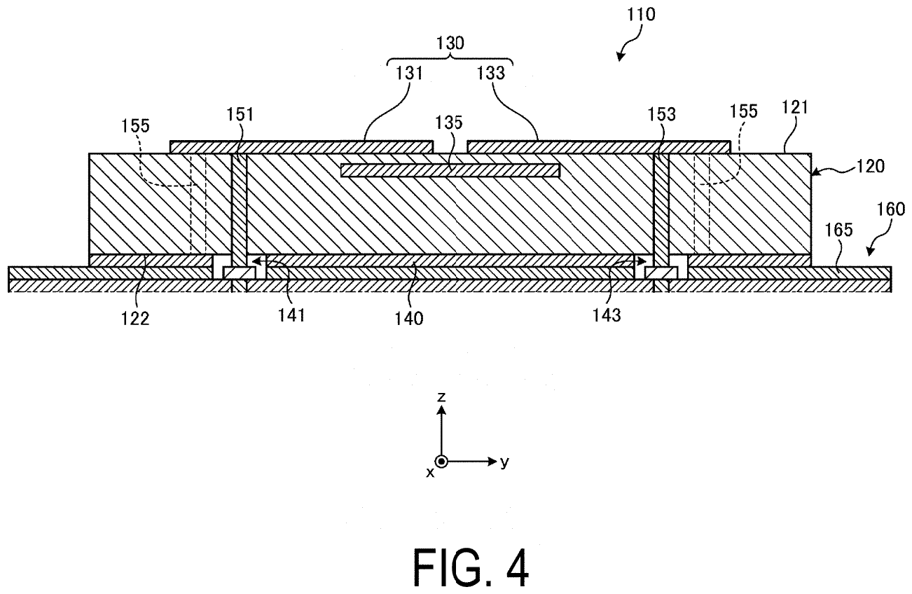

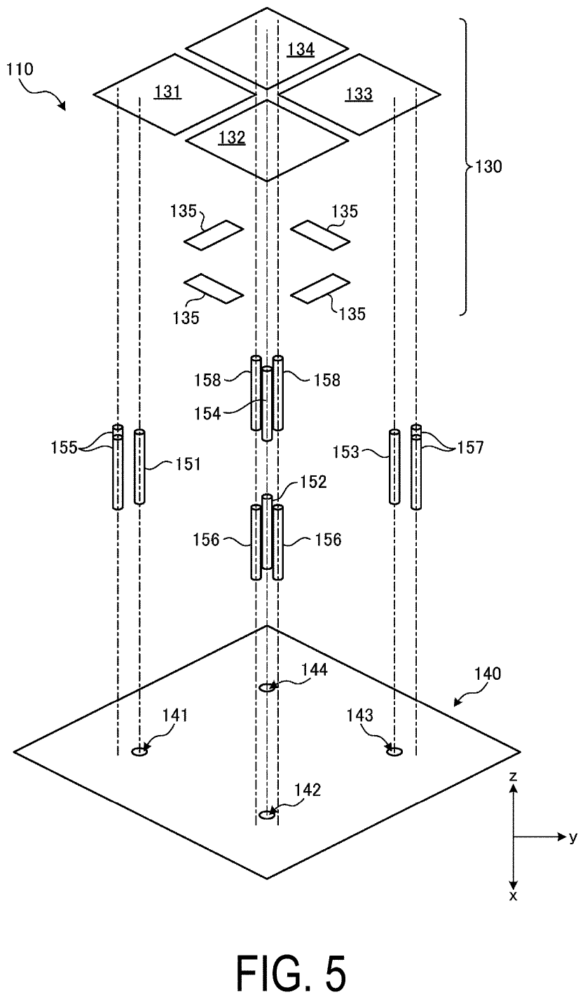

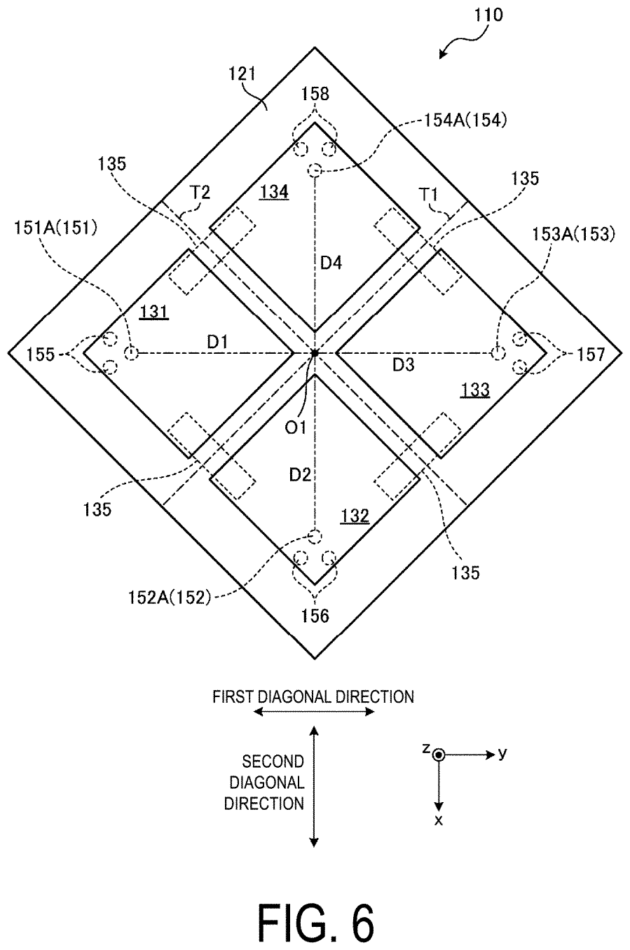

FIG. 2 is a schematic view of the antenna according to the embodiment. The antenna 15 includes an antenna body 110, a first variable phase unit 25, a second variable phase unit 26, a transmission side terminal 27, and a reception side terminal 28. First, the antenna body 110 will be described with reference to FIG. 3 to FIG. 6. FIG. 3 is a perspective view illustrating the antenna body according to the embodiment. FIG. 4 is a cross-sectional view of the antenna body taken along a line L1-L1 illustrated in FIG. 3. FIG. 5 is an exploded perspective view of a part of the antenna body illustrated in FIG. 3. FIG. 6 is a plan view for describing a configuration of a radiation conductor illustrated in FIG. 3.

As illustrated in FIG. 3 and FIG. 4, the antenna body 110 includes a base 120, a transmission/reception conductor 130, a ground conductor 140, first connection conductors 155, second connection conductors 156, third connection conductors 157, and fourth connection conductors 158. The antenna body 110 includes an electric wire 150 and a circuit substrate 160. The transmission/reception conductor 130, the ground conductor 140, and the electric wire 150 function as an antenna element 111. The electric wire 150 includes a first electric wire 151, a second electric wire 152, a third electric wire 153, and a fourth electric wire 154. Each number of the first connection conductors 155 to the fourth connection conductors 158 included in the antenna body 110 illustrated in FIG. 3 is two. However, each number of the first connection conductors 155 to the fourth connection conductors 158 included in the antenna body 110 may be one or three or more.

The antenna element 111 includes a first antenna element 111a at a transmission side and a second antenna element 111b at a reception side. The first antenna element 111a is capable of oscillating at a predetermined resonant frequency. The first antenna element 111a oscillates at a predetermined resonant frequency, causing the antenna body 110 to radiate an electromagnetic wave. The second antenna element 111b is capable of receiving an electromagnetic wave in a predetermined frequency band. The second antenna element 111b receives an electromagnetic wave, causing the antenna body 110 to acquire a reception signal. The antenna body 110 can use, as an operating frequency, at least one of resonant frequency bands of at least one of the antenna elements 111. The antenna body 110 can radiate an electromagnetic wave with the operating frequency. A wavelength of the operating frequency may be an operating wavelength that is a wavelength of the electromagnetic wave with the operating frequency of the antenna body 110.

The antenna element 111, as will be described below, exhibits an artificial magnetic conductor character with respect to an electromagnetic wave with a predetermined frequency incident on a surface of the antenna element 111 substantially parallel with an X-Y plane from the positive direction of a z axis. In the present disclosure, the “artificial magnetic conductor character” means a characteristic of a surface where a phase difference between an incident wave and a reflected wave at the operating frequency is 0 degrees. On the surface having the artificial magnetic conductor character, the phase difference between the incident wave and the reflected wave in the operating frequency band ranges from −90 degrees to +90 degrees. The operating frequency band includes the resonant frequency and the operating frequency that exhibit the artificial magnetic conductor character.

The antenna element 111 exhibits the artificial magnetic conductor character as described above, enabling the radiation efficiency of the antenna body 110 to be maintained when a ground conductor 165, which will be described later, of the circuit substrate 160 is positioned at the negative direction side of the z axis of the antenna body 110 as illustrated in FIG. 3.

The base 120 can include either a ceramic material or a resin material as a composition. Examples of the ceramic material include an aluminum oxide-based sintered body, an aluminum nitride-based sintered body, a mullite-based sintered body, a glass ceramic sintered body, crystallized glass yielded by precipitation of a crystal component in a glass base material, and a microcrystalline sintered body such as mica or aluminum titanate. Examples of the resin material include an epoxy resin, a polyester resin, a polyimide resin, a polyamide-imide resin, a polyetherimide resin, and resin materials yielded by curing an uncured product such as a liquid crystal polymer.

The base 120 is in contact with the transmission/reception conductor 130, the ground conductor 140, and the electric wire 150. The base 120 may have any shape depending on a shape of the transmission/reception conductor 130. The base 120 may be a substantially equilateral square pillar. The base 120 includes an upper surface 121 and a lower surface 122. The upper surface 121 and the lower surface 122 can respectively be the top surface and the bottom surface of the base 120, each of which is a substantially equilateral square pillar. The upper surface 121 and the lower surface 122 can be substantially parallel to the X-Y plane. Each of the upper surface 121 and the lower surface 122 can be substantially square. One diagonal line of two diagonal lines of each of the upper surface 121 and the lower surface 122 that are substantially square is along the x direction. The other diagonal line of the two diagonal lines is along the y direction. The upper surface 121 is positioned closer to the positive direction side of the z axis than the lower surface 122.

The transmission/reception conductor 130 and the ground conductor 140 may include any of a metal material, an alloy of metal materials, a cured product of metal paste, and an electrically conductive polymer as a composition. All of the transmission/reception conductor 130 and the ground conductor 140 may include the same material. All of the transmission/reception conductor 130 and the ground conductor 140 may include different materials. Any combination of the transmission/reception conductor 130 and the ground conductor 140 may include the same material. Examples of the metal material include copper, silver, palladium, gold, platinum, aluminum, chrome, nickel, cadmium lead, selenium, manganese, tin, vanadium, lithium, cobalt, and titanium. The alloy includes a plurality of metal materials. The metal paste includes the result of kneading a powder of a metal material with an organic solvent and a binder. Examples of the binder include an epoxy resin, a polyester resin, a polyimide resin, a polyamide-imide resin, and a polyetherimide resin. Examples of the electrically conductive polymer include a polythiophene polymer, a polyacetylene polymer, a polyaniline polymer, and a polypyrrole polymer.

The transmission/reception conductor 130 functions as a transmitter and a receiver, and the transmitter functions as a resonator. As illustrated in FIG. 4, the transmission/reception conductor 130 may be positioned on the upper surface 121 of the base 120. The transmission/reception conductor 130 expands along the X-Y plane. The transmission/reception conductor 130 is configured to capacitively connect the connection conductors, which are the first connection conductors 155 to the fourth connection conductors 158. The periphery of the transmission/reception conductor 130 is surrounded by the first connection conductors 155 to the fourth connection conductors 158 on the X-Y plane.

The transmission/reception conductor 130 can resonate in the y direction by being supplied with electrical signals having reverse phases to each other from the respective first electric wire 151 and third electric wire 153, for example. When the transmission/reception conductor 130 resonates in the y direction, from the transmission/reception conductor 130, the first connection conductors 155 can be seen as an electric wall positioned at the negative direction side of the y axis, and the third connection conductors 157 can be seen as an electric wall positioned at the positive direction side of the y axis. When the transmission/reception conductor 130 resonates in the y direction, from the transmission/reception conductor 130, the positive direction side of the x axis can be seen as a magnetic wall, and the negative direction side of the x axis can be seen as a magnetic wall. When the transmission/reception conductor 130 resonates in the y direction, the transmission/reception conductor 130 is surrounded by these two electric walls and two magnetic walls, and thus, the antenna body 110 exhibits the artificial magnetic conductor character with respect to electromagnetic waves with a predetermined frequency incident on the X-Y plane included in the antenna body 110 from the positive direction side of the z axis.

The transmission/reception conductor 130 may be configured to resonate in the x direction by electromagnetic waves with a predetermined frequency incident on the X-Y plane included in the antenna body 110 from the negative direction side of the z axis and output an electrical signal with a reverse phase from each of the second electric wire 152 and the fourth electric wire 154. When the transmission/reception conductor 130 resonates in the x direction, from the transmission/reception conductor 130, the second connection conductors 156 can be seen as an electric wall positioned at the positive direction side of the x axis, and the fourth connection conductors 158 can be seen as an electric wall positioned at the negative direction side of the x axis. When the transmission/reception conductor 130 resonates in the x direction, from the transmission/reception conductor 130, the positive direction side of the y axis can be seen as a magnetic wall, and the negative direction side of the y axis can be seen as a magnetic wall. When the transmission/reception conductor 130 resonates in the x direction, the transmission/reception conductor 130 is surrounded by these two electric walls and two magnetic walls, and thus, the antenna body 110 exhibits the artificial magnetic conductor character with respect to electromagnetic waves with a predetermined frequency incident on the X-Y plane included in the antenna body 110 from the positive direction side of the z axis.

As illustrated in FIG. 6, the transmission/reception conductor 130 includes a center O1. The center O1 is the center in both the x direction and the y direction of the transmission/reception conductor 130. The transmission/reception conductor 130 can include a first symmetric axis T1 that extends along the X-Y plane. The first symmetric axis T1 extends through the center O1 in a direction intersecting with the x direction and the y direction. The first symmetric axis T1 may extend along a direction tilted by 45 degrees from the positive direction of the y axis toward the negative direction of the x axis. The transmission/reception conductor 130 may include a second symmetric axis T2 that extends along the X-Y plane. The second symmetric axis T2 extends through the center O1 in a direction intersecting with the first symmetric axis T1. The second symmetric axis T2 may extend along a direction tilted by 45 degrees from the positive direction of the y axis toward the positive direction of the x axis. The transmission/reception conductor 130 may have half the size of the operating wavelength. For example, a length of the transmission/reception conductor 130 in the x direction and a length of the transmission/reception conductor 130 in the y direction may be half the operating wavelength.

As illustrated in FIG. 5, the transmission/reception conductor 130 includes a first conductor 131, a second conductor 132, a third conductor 133, and a fourth conductor 134. The transmission/reception conductor 130 further includes capacitive elements 135. All of the first conductor 131 to the fourth conductor 134, the capacitive elements 135, the ground conductor 140, the first electric wire 151, the second electric wire 152, the third electric wire 153, the fourth electric wire 154, and the first connection conductors 155 to the fourth connection conductors 158 may contain the same material, or may contain different materials. Any combination of the first conductor 131 to the fourth conductor 134, the capacitive elements 135, the ground conductor 140, the first electric wire 151, the second electric wire 152, the third electric wire 153, and the fourth wire 154, and the first connection conductors 155 to the fourth connection conductors 158 may contain the same material.

The first conductor 131 to the fourth conductor 134 may have, for example, the same shape that is substantially square. Two diagonal lines of the first conductor 131 being substantially square and two diagonal lines of the third conductor 133 that is substantially square are along the x direction and the y direction. A length of the diagonal line along the y direction of the first conductor 131 and a length of the diagonal line along the y direction of the third conductor 133 may be approximately a quarter of the operating wavelength. Two diagonal lines of the second conductor 132 that is substantially square and two diagonal lines of the fourth conductor 134 that is substantially square are along the x direction and the y direction. A length of the diagonal line along the x direction of the second conductor 132 and a length of the diagonal line along the x direction of the fourth conductor 134 may be approximately a quarter of the operating wavelength.

At least a part of each of the first conductor 131 to the fourth conductor 134 may be exposed to the outside of the base 120. A part of each of the first conductor 131 to the fourth conductor 134 may be positioned inside the base 120. The entire of each of the first conductor 131 to the fourth conductor 134 may be positioned inside the base 120.

The first conductor 131 to the fourth conductor 134 expand along the upper surface 121 of the base 120. As an example, the first conductor 131 to the fourth conductor 134 may be aligned in a square lattice shape on the upper surface 121. In this case, the first conductor 131 and the fourth conductor 134; and the second conductor 132 and the third conductor 133 may be aligned along the first symmetric axis T1. The first conductor 131 and the second conductor 132; and the fourth conductor 134 and the third conductor 133 may be aligned along the second symmetric axis T2. The two diagonal directions of the square lattice aligned with the first conductor 131 to the fourth conductor 134 are along the x direction and the y direction. Of the two diagonal directions, the diagonal direction along the y direction is described as a first diagonal direction. Of the two diagonal directions, the diagonal direction along the x direction is described as a second diagonal direction. The first diagonal direction and the second diagonal direction may intersect with each other at the center O1.

The first conductor 131 to the fourth conductor 134 are positioned at predetermined intervals so as to be separated from one another. For example, as illustrated in FIG. 3, the first conductor 131 and the second conductor 132 are positioned at an interval t1 so as to be separated from each other. The third conductor 133 and the fourth conductor 134 are positioned at the interval t1 so as to be separated from each other. The first conductor 131 and the fourth conductor 134 are positioned at an interval t2 so as to be separated from each other. The second conductor 132 and the third conductor 133 are positioned at the interval t2 so as to be separated from each other. The first conductor 131 to the fourth conductor 134 are configured to be capacitively connected to one another by being positioned at the predetermined intervals and separated from one another.

As illustrated in FIG. 5, the capacitive elements 135 face the first conductor 131 to the fourth conductor 134 in the z direction. The capacitive elements 135 are positioned closer to the negative direction side of the z axis than the first conductor 131 to the fourth conductor 134. Four capacitive elements 135 are provided as illustrated in FIG. 6. The capacitive elements 135 may be positioned inside the base 120. However, when the entirety of each of the first conductor 131 to the fourth conductor 134 is positioned inside the base 120, the capacitive elements 135 may be positioned on the positive direction side of the z axis of the first conductor 131 to the fourth conductor 134. In this case, at least a part of the capacitive element 135 may be exposed from the upper surface 121 of the base 120.

The capacitive elements 135 are configured to capacitively connect each of the first conductor 131 to the fourth conductor 134. For example, a part of the base 120 may be positioned between the respective capacitive elements 135 and the first conductor 131 to the fourth conductor 134. A part of the base 120 is positioned between the respective capacitive elements 135 and the first conductor 131 to the fourth conductor 134, and thus, the respective capacitive elements 135 are configured to capacitively connect each of the first conductor 131 to the fourth conductor 134. An area of each of the capacitive elements 135 on the X-Y plane may be appropriately adjusted in consideration of a desired magnitude of each capacitive coupling between the respective capacitive elements 135 and the first conductor 131 to the fourth conductor 134. Distances between the first conductor 131 to the fourth conductor 134 and the respective capacitive elements 135 in the z direction may be adjusted as appropriate in consideration of a desired magnitude of capacitive coupling between the first conductor 131 to the fourth conductor 134 and the respective capacitive elements 135.

Each capacitive element 135 may be substantially parallel to the X-Y plane. The capacitive element 135 may be substantially rectangular. The four capacitive elements 135 that are substantially rectangular are a capacitive element 135 that connects between the first conductor 131 and the second conductor 132, a capacitive element 135 that connects between the second conductor 132 and the third conductor 133, a capacitive element 135 that connects between the third conductor 133 and the fourth conductor 134, and a capacitive element 135 that connects between the fourth conductor 134 and the first conductor 131. The four capacitive elements 135 are provided at the outer edge sides of the first conductor 131 to the fourth conductor 134 with respect to the center O1.

The ground conductor 140 may function as a ground of the antenna element 111. As illustrated in FIG. 4, the ground conductor 140 may be connected to the ground conductor 165, which will be described later, of the circuit substrate 160. In this case, the ground conductor 140 may be integrated with the ground conductor 165 of the circuit substrate 160. The ground conductor 140 may be a conductor having a flat plate shape. The ground conductor 140 is positioned on the lower surface 122 of the base 120.

As illustrated in FIG. 5, the ground conductor 140 expands along the X-Y plane. The ground conductor 140 faces the transmission/reception conductor 130 in the z direction. The base 120 is interposed between the ground conductor 140 and the transmission/reception conductor 130. The ground conductor 140 may have a shape corresponding to the shape of the transmission/reception conductor 130. In the present embodiment, the ground conductor 140 has a substantially square shape corresponding to the transmission/reception conductor 130 having a substantially square shape. However, the ground conductor 140 may have any shape corresponding to the transmission/reception conductor 130. The ground conductor 140 includes openings 141, 142, 143, and 144. Positions on the X-Y plane of the openings 141 to 144 may be adjusted as appropriate according to positions on the X-Y plane of the first electric wire 151 to the fourth electric wire 154.

The electric wire 150 may be configured to supply electrical signals from the outside to the antenna element 111. The electric wire 150 may be configured to supply electrical signals from the antenna element 111 to the outside. The electric wire 150 may be a through hole conductor, a via conductor, or the like. The electric wire 150 is configured to be capable of supplying electrical signals from the antenna element 111 to the circuit substrate 160 positioned at the outside thereof or the like. The first electric wire 151 to the fourth electric wire 154 individually contact the transmission/reception conductor 130 at different positions from each other. For example, as illustrated in FIG. 3, the first electric wire 151 is electrically connected to the first conductor 131. The second electric wire 152 is electrically connected to the second conductor 132. The third electric wire 153 is electrically connected to the third conductor 133. The fourth electric wire 154 is electrically connected to the fourth conductor 134. However, the first electric wire 151 to the fourth electric wire 154 may be configured to be magnetically connected to the first conductor 131 to the fourth conductor 134, respectively. Positions where the first electric wire 151 to the fourth electric wire 154 are respectively connected to the first conductor 131 to the fourth conductor 134 are also described as a feeding point 151A, a feeding point 152A, a feeding point 153A, and a feeding point 154A. As illustrated in FIG. 4, the first electric wire 151 to the fourth electric wire 154 are communicated with the outside through the openings 141 to 144 of the ground conductor 140, respectively. Each of the first electric wire 151 to the fourth electric wire 154 may extend along the z direction.

The first electric wire 151 and the third electric wire 153 are configured to contribute to at least the supply of electrical signals (transmission signals) to the outside when the transmission/reception conductor 130 resonates in the y direction. The second electric wire 152 and the fourth electric wire 154 are configured to contribute to at least the supply of electrical signals (reception signals) to the reception circuit 17 when the transmission/reception conductor 130 resonates in the x direction.

The first electric wire 151 and the third electric wire 153, and the second electric wire 152 and the fourth electric wire 154 are configured to cause the transmission/reception conductor 130 to be excited in different directions. For example, the first electric wire 151 and the third electric wire 153 are configured to cause the transmission/reception conductor 130 to be excited in the y direction (a first direction). The second electric wire 152 and the fourth electric wire 154 are configured to cause the transmission/reception conductor 130 to be excited in the x direction (a second direction). With such an electric wire 150, when the transmission/reception conductor 130 is excited in one direction, the antenna body 110 can reduce the excitation of the transmission/reception conductor 130 in the other direction.

The first electric wire 151 and the third electric wire 153 are configured to cause the transmission/reception conductor 130 to be excited at a differential voltage. The second electric wire 152 and the fourth electric wire 154 are configured in a manner that the differential voltage is generated by the excitation of the transmission/reception conductor 130. The antenna body 110 can reduce the fluctuation of the center of potential in the excitation of the transmission/reception conductor 130 from the center O1 of the transmission/reception conductor 130 by causing the transmission/reception conductor 130 to be excited at the differential voltage.

As illustrated in FIG. 6, in the y direction, the center O1 of the transmission/reception conductor 130 is positioned between the first electric wire 151 and the third electric wire 153. A first distance D1 between the first electric wire 151 and the center O1 and a third distance D3 between the third electric wire 153 and the center O1 are substantially equal.

As illustrated in FIG. 6, in the x direction, the center O1 of the transmission/reception conductor 130 is positioned between the second electric wire 152 and the fourth electric wire 154. A second distance D2 between the second electric wire 152 and the center O1 and a fourth distance D4 between the fourth electric wire 154 and the center O1 are substantially equal. In this embodiment, the second distance D2 is substantially equal to the first distance D1. However, the second distance D2 may be different from the first distance D1.

The first electric wire 151 and the second electric wire 152 may have symmetry across the first symmetric axis T1. The third electric wire 153 and the fourth electric wire 154 may have symmetry across the first symmetric axis T1. For example, the feeding point 151A and the feeding point 152A may be line-symmetric and the feeding point 153A and the feeding point 154A may be line-symmetric, with the first symmetric axis T1 serving as an axis.

The first electric wire 151 and the fourth electric wire 154 may have symmetry across the second symmetric axis T2. The second electric wire 152 and the third electric wire 153 may have symmetry across the second symmetric axis T2. For example, the feeding point 151A and the feeding point 154A may be line-symmetric and the feeding point 152A and the feeding point 153A may be line-symmetric, with the second symmetric axis T2 serving as an axis.

A direction of connecting the first electric wire 151 and the third electric wire 153 is along the y direction. The direction of connecting the first electric wire 151 and the third electric wire 153 is along a first diagonal direction. A direction of connecting the second electric wire 152 and the fourth electric wire 154 is along the x direction. The direction of connecting the second electric wire 152 and the fourth electric wire 154 is along a second diagonal direction.

As illustrated in FIG. 4, the circuit substrate 160 includes the ground conductor 165. The ground conductor 165 contains any electrically conductive material. The ground conductor 165 may be an electrical conductor layer. The ground conductor 165 is positioned on the surface positioned at the positive direction side of the z axis, of the two surfaces included in the circuit substrate 160 that are substantially parallel to the X-Y plane. As illustrated in FIG. 2, the circuit substrate 160 includes the first variable phase unit 25, the second variable phase unit 26, the transmission side terminal 27, and the reception side terminal 28.

The first variable phase unit 25 includes two first variable phase shifters 31 and a first inverter circuit 32. The two first variable phase shifters 31 are individually connected to the first electric wire 151 and the third electric wire 153 that constitute the first antenna element 111a. The two first variable phase shifters 31 are circuits that change the phase of the frequency of an electromagnetic wave in the first conductor 131 and the third conductor 133. The two first variable phase shifters 31 are electrically connected to the controller 20. The controller 20 controls the two first variable phase shifters 31 to change the phase of a transmission analog signal to be transmitted from the first antenna element 111a.

The first inverter circuit 32 is provided between the two first variable phase shifters 31 and electrically connects the two first variable phase shifters 31. The first inverter circuit 32 may be any of a balun, a power distribution circuit, and a delay line (delay line memory). The first inverter circuit 32 makes a resistance value from the first inverter circuit 32 to the feeding point 151A and a resistance value from the first inverter circuit 32 to the feeding point 153A substantially equal.

The second variable phase unit 26 includes two second variable phase shifters 34 and a second inverter circuit 35. The two second variable phase shifters 34 are individually connected to the second electric wire 152 and the fourth electric wire 154 that constitute the second antenna element 111b. The two second variable phase shifters 34 are circuits that change the phase of the frequency of an electromagnetic wave in the second conductor 132 and the fourth conductor 134. The two second variable phase shifters 34 are electrically connected to the controller 20. The controller 20 controls the two second variable phase shifters 34 to change the phase of a reception analog signal received by the second antenna element 111b.

The second inverter circuit 35 is provided between the two second variable phase shifters 34 and electrically connects the two second variable phase shifters 34. The second inverter circuit 35 may be, similarly to the first inverter circuit 32, any of a balun, a power distribution circuit, and a delay line (delay line memory). The second inverter circuit 35 makes resistance values from the second inverter circuit 35 to the feeding point 152A and the feeding point 154A be substantially equal to each other.

The transmission side terminal 27 is connected to the first inverter circuit 32. Furthermore, the transmission side terminal 27 is connected to the transmission circuit 16.

The reception side terminal 28 is connected to the second inverter circuit 35. Also, the reception side terminal 28 is connected to the reception circuit 17.

The antenna 15 as described above is an antenna having an isolation characteristic between the first antenna element 111a at the transmission side and the second antenna element 111b at the reception side.

The transmission circuit 16 is a digital-to-analog (D/A) converter, converts a digital transmission signal input from the controller 20 into an analog transmission signal, and outputs the converted analog transmission signal to the antenna 15.

The reception circuit 17 is an analog-to-digital (A/D) converter, converts an analog reception signal input from the antenna 15 into a digital reception signal, and outputs the converted digital reception signal to the controller 20.

The cancel circuit 18 cancels noise included in the reception signal. The cancel circuit 18 acquires a leakage signal of a transmission wave from the transmission circuit 16. The cancel circuit 18 generates a cancel signal for cancelling the noise included in the reception signal of the reception circuit 17 based on the acquired leakage signal. The cancel circuit 18 outputs the generated cancel signal to the reception circuit 17. The reception circuit 17 cancels the noise included in the reception signal based on the cancel signal.

The controller 20 comprehensively controls operations of the communication module 10 to implement various functions. The controller 20 includes integrated circuits such as a central processing unit (CPU), a field-programmable gate array (FPGA), and the like. Specifically, the controller 20 executes a program for controlling the isolation of the antenna 15 or executes a program for controlling the cancel circuit 18.

The communication module 10 described above controls the isolation of the first antenna element 111a at the transmission side by controlling the two first variable phase shifters 31 of the antenna 15 by the controller 20. In addition, the communication module 10 controls the isolation of the second antenna element 111b at the reception side by controlling the two second variable phase shifters 34 of the antenna 15 by the controller 20. Furthermore, the communication module 10 controls the noise of the reception signal by controlling the cancel circuit 18 of the antenna 15 by the controller 20, thereby ensuring the isolation between the first antenna element 111a and the second antenna element 111b.

Each of the plurality of communication terminals 12 includes an antenna 41, a wireless communication circuit 42, and a sensor 43. The antenna 41 is only required to be capable of performing transmission to and/or reception from the communication module 10, and may be, for example, a dipole antenna or the like. The antenna 41 may be a circular polarization antenna, or an antenna performing conversion to an orthogonal polarization wave. The wireless communication circuit 42 is, for example, a radio frequency integrated circuit (RFIC), and is electrically connected to the antenna 41. The wireless communication circuit 42 is input with a signal from the communication module 10 through the antenna 41, and outputs a signal through the antenna 41 toward the communication module 10. The sensor 43 is electrically connected to the wireless communication circuit 42. The sensor 43 may be any sensor, and outputs the detection result by sensing to the wireless communication circuit 42.

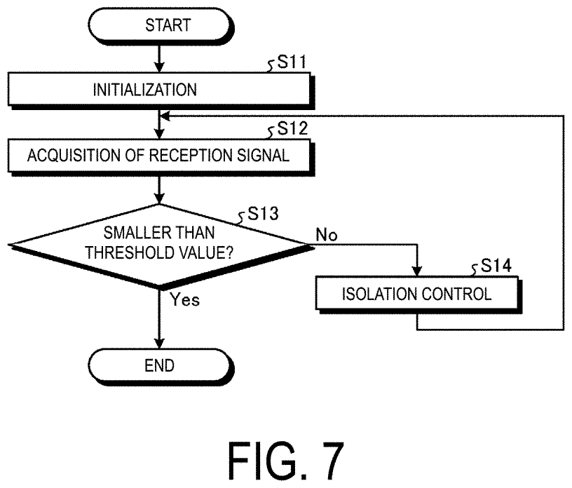

Next, with reference to FIG. 7, an example of a method for controlling the communication module 10 will be described. FIG. 7 is a flowchart of an example related to the method for controlling the communication module according to the embodiment. Specifically, as the method for controlling the communication module 10, isolation control of the antenna 15 of the communication module 10 is represented. In the isolation control illustrated in FIG. 7, communication with the plurality of communication terminals 12 is performed in order one by one.

The communication module 10 is initialized so as to be in an initial state (step S11). The communication module 10 receives a transmission wave from the first antenna element 111a in the initial state as a reception wave and acquires a reception signal (step S12). When the reception signal is acquired, the controller 20 of the communication module 10 determines whether a signal level of the acquired reception signal is smaller than a preset threshold value or not (step S13). In step S13, for example, a minimum value is set as the threshold value. In step S13, when the controller 20 determines that the signal level is not smaller than the threshold value (step S13: NO), the controller 20 executes the isolation control of the antenna 15 (step S14).

In step S14, the controller 20 controls the isolation of the first antenna element 111a at the transmission side by controlling the two first variable phase shifters 31 of the antenna 15. In other words, the controller 20 controls the isolation of the first antenna element 111a such that the signal level of the reception signal is smaller than the threshold value. Similarly, in step S14, the controller 20 controls the isolation of the second antenna element 111b at the reception side by controlling the two second variable phase shifters 34 of the antenna 15. In other words, the controller 20 controls the isolation of the second antenna element 111b such that the signal level of the reception signal is smaller than the threshold value. Note that in step S14, the isolation of at least one of the first antenna element 111a or the second antenna element 111b can be controlled. After performing step S14, the controller 20 proceeds to step S12 again.

In step S13, when the controller 20 determines that the signal level of the reception signal is smaller than the threshold value (step S13: YES), the controller 20 terminates the isolation control because of the fact that an isolation characteristic is held between the first antenna element 111a and the second antenna element 111b.

Note that in step S14, the controller 20 controls the two first variable phase shifters 31 and the two second variable phase shifters 34 of the antenna 15 but may control the capacitive elements 135. That is, in step S14, the controller 20 may control the isolation between the first antenna element 111a and the second antenna element 111b by adjusting capacitances of the four capacitive elements 135.

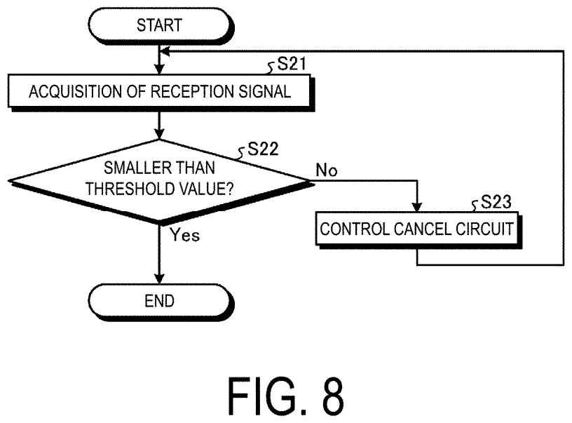

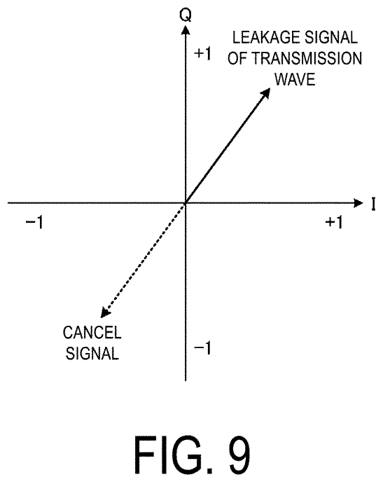

Next, with reference to FIG. 8 and FIG. 9, an example of a method for controlling the communication module 10 will be described. FIG. 8 is a flowchart of an example related to the method for controlling the communication module according to the embodiment. FIG. 9 is an explanatory diagram of a cancel signal. Specifically, as the method for controlling the communication module 10, the control of the cancel circuit 18 of the communication module 10 is represented. Note that the control of the cancel circuit 18 illustrated in FIG. 8 is performed after the isolation control illustrated in FIG. 7. Additionally, the control of the cancel circuit 18 illustrated in FIG. 8 is also performed on the plurality of communication terminals 12 in order one by one in a similar manner to that in FIG. 7.

The communication module 10 receives a reception wave from the communication terminal 12 and acquires a reception signal (step S21). When the reception signal is acquired, the controller 20 of the communication module 10 determines whether a signal level of the acquired reception signal is smaller than a preset threshold value or not (step S22). In step S22, for example, a minimum value is set as the threshold value. In step S22, when the controller 20 determines that the signal level is not smaller than the threshold value (step S22: NO), the control of the cancel circuit 18 is performed (step S23).

In step S23, the controller 20 adjusts a cancel signal generated by the cancel circuit 18. As illustrated in FIG. 9, a leakage signal of a transmission wave includes an I signal with the same phase and a Q signal with an orthogonal phase. The controller 20 acquires the leakage signal of the transmission wave from the transmission circuit 16 and generates a cancel signal for canceling the leakage signal. In other words, the controller 20 generates the cancel signal such that the signal level of the reception signal is smaller than the threshold value. Specifically, in step S23, the controller 20 generates a cancel signal by fixing a Q signal of the cancel signal and changing an I signal of the cancel signal. Thereafter, in step S23, the controller 20 generates a cancel signal by fixing an I signal of the cancel signal and changing a Q signal of the cancel signal. After performing step S23, the controller 20 proceeds to step S21 again.

In step S22, when the controller 20 determines that the signal level of the reception signal is smaller than the threshold value (step S22: YES), the controller 20 terminates the control of the cancel circuit 18 because of the fact that an isolation characteristic is held between the first antenna element 111a and the second antenna element 111b.

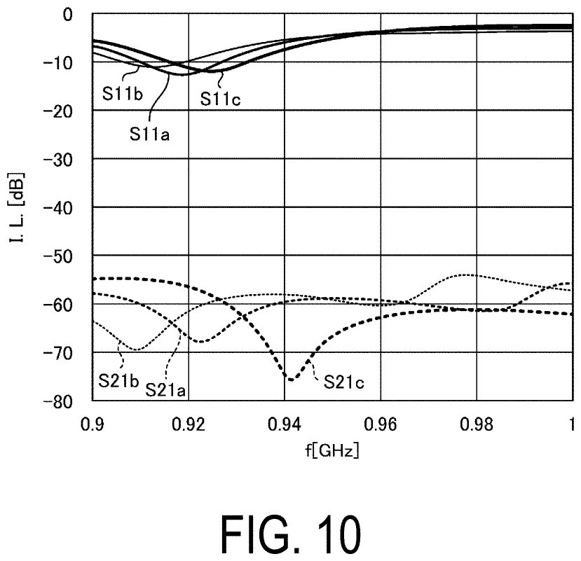

Next, attenuation characteristics of the antenna will be described with reference to FIG. 10. FIG. 10 is a graph showing the attenuation characteristics of the antenna, with respect to frequencies. In FIG. 10, a horizontal axis thereof represents frequencies of electromagnetic waves, and a vertical axis thereof represents attenuation characteristics. In FIG. 10, S11a to S11c represent reflection characteristics, and S21a to S21c represent pass characteristics. Also, S11a and S21a represent attenuation characteristics when the phase is an initial phase (for example, 0°), S11b and S21b represent attenuation characteristics when the phase is changed from the initial phase to +30°, and S11c and S21c represent attenuation characteristics when the phase is changed from the initial phase to −30°. As illustrated in FIG. 10, it has been recognized that attenuation poles could be changed in a predetermined frequency band by controlling the two first variable phase shifters 31 and two second variable phase shifters 34 of the antenna 15.

As described above, in the communication module 10 according to the embodiment and the method for controlling the communication module 10, the controller 20 can control at least one of the first variable phase unit 25 or the second variable phase unit 26 to control the isolation of the antenna 15. Thus, since the isolation of the antenna 15 can be appropriately adjusted according to the reception environment, it is possible to suitably acquire reception signals from the plurality of communication terminals 12.

Additionally, in the communication module 10 according to the embodiment, the controller 20 can control the capacitive elements 135 to control the isolation of the antenna 15. Thus, the isolation of the antenna 15 can be appropriately adjusted depending on the reception environment.

Further, in the communication module 10 according to the embodiment, the controller 20 can control the cancel circuit 18 to cancel the noise of the transmission wave included in the reception signal. Thus, the isolation of the antenna 15 can be appropriately adjusted depending on the reception environment.

Additionally, with the communication module 10 according to the embodiment, the signal level of a reception signal acquired at the antenna 15 can be made smaller than a preset setting value. Thus, the noise included in the reception signal can be suitably reduced.

Additionally, in the communication module 10 according to the embodiment, the third electric wire 153 of the antenna body 110 is positioned at the side opposite to the first electric wire 151 in they direction as viewed from the center O1 of the transmission/reception conductor 130, and the fourth electric wire 154 is positioned at the side opposite to the second electric wire 152 in the x direction as viewed from the center of the transmission/reception conductor 130. Thus, the antenna 15 having an isolation characteristic between the first antenna element 111a and the second antenna element 111b can be used.

Furthermore, in the communication system 1 according to the embodiment, communication can be suitably performed even when installation environment changes between the communication module 10 and the communication terminal 12.

Note that, in the embodiment, the cancel circuit 18 is used, but a configuration may be employed in which the cancel circuit 18 is omitted as long as the controller 20 controls at least one of the first variable phase unit 25 or the second variable phase unit 26 to sufficiently ensure the isolation characteristic.

Additionally, in the embodiment, the cancel circuit 18 is controlled after the first variable phase unit 25 and the second variable phase unit 26 of the antenna 15 are controlled, but the embodiment is not limited thereto, and the first variable phase unit 25 and the second variable phase unit 26 may be controlled after the cancel circuit is controlled.

1. A communication module, comprising:
an antenna comprising a first antenna element at a transmission side and a second antenna element at a reception side and having an isolation characteristic between the first antenna element and the second antenna element;
a transmission circuit connected to the first antenna element;
a reception circuit connected to the second antenna element; and
a controller configured to control the antenna, the transmission circuit, and the reception circuit,
the antenna comprising
a first variable phase unit configured to vary a phase of a transmission wave to be transmitted from the first antenna element, and
a second variable phase unit configured to vary a phase of a reception wave to be received by the second antenna element, wherein
the controller controls at least one of the first variable phase unit or the second variable phase unit to control an isolation of the antenna.

2. The communication module according to claim 1, wherein
the controller is configured to receive the reception wave at the second antenna element to acquire a reception signal from the reception circuit and controls at least one of the first variable phase unit or the second variable phase unit in a manner that a signal level of the reception signal acquired is smaller than a preset setting value.

3. The communication module according to claim 1, wherein
the antenna further comprises a capacitive element configured to electrically connect the first antenna element and the second antenna element, and
the controller variably controls a capacitance of the capacitive element to control the isolation of the antenna.

4. The communication module according to claim 3, wherein
the controller receives the reception wave at the second antenna element to acquire a reception signal from the reception circuit and variably controls the capacitance of the capacitive element in a manner that a signal level of the reception signal acquired is smaller than a preset setting value.

5. The communication module according to claim 1, further comprising:
a cancel circuit configured to acquire a leakage signal of the transmission wave from the transmission circuit and generate, in accordance with the leakage signal, a cancel signal to cancel noise included in a reception signal of the reception circuit.

6. The communication module according to claim 5, wherein
the cancel signal comprises an I signal with the same phase and a Q signal with an orthogonal phase, and
the controller receives the reception wave at the second antenna element to acquire a reception signal from the reception circuit, and
controls a signal level of at least one of the I signal or the Q signal of the cancel signal in a manner that a signal level of the reception signal acquired is smaller than a preset setting value.

7. The communication module according to claim 1, wherein
the antenna comprises
a transmission/reception conductor comprising the first antenna element and the second antenna element,
a ground conductor,
a first electric wire configured to be electromagnetically connected to the transmission/reception conductor,
a second electric wire configured to be electromagnetically connected to the transmission/reception conductor,
a third electric wire configured to be electromagnetically connected to the transmission/reception conductor, and
a fourth electric wire configured to be electromagnetically connected to the transmission/reception conductor,
the third electric wire is positioned at a side opposite to the first electric wire in a first direction as viewed from a center of the transmission/reception conductor, and
the fourth electric wire is positioned at a side opposite to the second electric wire in a second direction as viewed from the center of the transmission/reception conductor.

8. A communication system, comprising:
the communication module according to claim 1; and
a communication terminal configured to communicate with the communication module.

9. A method for controlling the communication module according to claim 1, the method comprising:
by the controller,
receiving the reception wave at the second antenna element to acquire a reception signal from the reception circuit; and
controlling at least one of the first variable phase unit or the second variable phase unit in a manner that a signal level of the reception signal acquired is smaller than a preset setting value.
